(19) United States
(12) Patent Application Publication
(10) Pub. No.: US 2002/0121333 A1
(43) Pub. Date: Sep. 5, 2002

(54) Applying digitally created graphic images to leather (Cow hide, Calf, Pig, Goat, Kid, and sheep skin)

(76) Inventors: Michael Sofer, Los Angeles, CA (US); Jacques Sofer, Los Angeles, CA (US)

Correspondence Address: Michael Sofer, Suite 505, 10390 Wilshire Blvd., Los Angeles, CA, 90024, US

(21) Appl. No.: 09/798,080

(22) Filed: Mar. 5, 2001

(51) Int. Cl. B44C 1/00

(52) U.S. Cl. 156/240; 156/289; 156/277

(57) ABSTRACT

A method using a personal computer creating creative designs and or images. The design is first created on the computer and then printed onto a heat transfer sheet. The printed design on the heat transfer sheet is then heat pressed onto the leather (Cow hide, Calf, Pig, Goat, Kid, Sheep) material. The design may also be an image such as a picture created using a digital camera or manual camera.

### BACKGROUND OF THE INVENTION

The present invention relates to a method for applying an image such as a photograph using a computer to leather (Cow hide, Calf, Pig, Goat, Kid, and Sheep) materials using a heating step.

In recent years, leather (Cow hide, Calf, Pig, Goat, kid, and Sheep) materials with limited designs thereon have become very popular. A large number of leather goods are sold without any pre-printed designs to consumers. Many leather goods are sold in stores worldwide.

Also, in recent years, apparel with a variety of designs thereon has become very popular. A large number of apparels are sold with pre-printed designs to suit the various tastes of consumers. Processes have also been proposed for permitting customers to create their own designs on transfer sheets for application to apparel by use of a conventional heat press, such as described in U.S. Pat. No. 4,224,358, issued Sept. 23, 1980.

One problem in the art is that the internal heat of toner laser imaging devices exceeds the melt point of any “heat press” transfer. The problem has been apparent for 20 years when Xerox introduced its first commercial toner color copier. In 20 years, no one has found a successful method to achieve heat pressing of toner laser transfers.

The modifications will follow description of the fundamental 20 years inability to hand heat press laser toner transfers. All transfers must have a melting point higher than the fuser rollers within toner copiers. This melting point is a combination of temperature, the amount of time that the transfer is in contact with fuser roller, and pressure applied to transfer as it passes over the roller.

Papers are available but each can only pass through the copier with an imprinted image, and not melt when undergoing the printing procedure. However, because the melting point must be so high (350-400.degree. F. for 20 seconds) the transfer must be heat pressed. Should one try to heat press, the heat press would have to be, at its highest temperature, until the 8.5″ by 11″ or 11″ by 17″ transfer had been completely covered with the heat press for 20 seconds. When the heat press had been completed, and peel of transfer begun, you will often find that the transfers which had been pressed had since cooled and the transfer must stick to the leather (Cowhide, Calf, Pig, Goat, Kid, and Sheepskin) material. One could never peel the transfer from the leather (Cowhide, Calf, Pig, Goat, Kid, and Sheepskin) material without a great deal of difficulty (i.e., resistance to peel). This drag would lift the piles of the leather (Cow hide, Calf, Pig, Goat, Kid, and Sheep skin) material upward thus leaving the color unprotected at the extreme tips of the fibers. The present inventor found that if the colored coating is not compressed into the leather (Cow hide, Calf, Pig, Goat, Kid, and Sheep skin) material, color will be significantly lost, coatings will develop cracks, feel will be rough, and colors are less vibrant.

### DESCRIPTIONS OF PRIOR ART

Many exemplary heat transferable or pressure transferable decals for placing a color emblem on a fabric or other receptor sheet are illustrated in the prior art. For example, U.S. Pat. No. 2,071,163 to Emmey discloses a transfer sheet 13 having colored areas 14, 15 thereon formed from a heat transferable wax. The heat transferable wax 14, 15 is applied to the transfer sheet 13 in a melted state at the time of manufacture of the transfer sheet.

U.S. Pat. No. 2,217,270 to Gibbs and U.S. Pat. No. 2,688,579 to Meyer disclose other forms of pre-colored transfer sheets. The transfer sheets in these patents, like the transfer sheet of Emmey, are pre-colored at the time of manufacture of the transfer sheet.

U.S. Pat. No. 3,783,073 to Warnberg and U.S. Pat. No. 4,038,123 to Simms disclose devices for transferring outlines of indicia to fabrics.

Each of the foregoing patents suffers from the disadvantage that they do not permit or encourage creative artwork in the design transferred to the fabric.

At least one custom coloring procedure for applying color designs to T-shirts or other fabrics is known. In this procedure, fabric crayons are sold separately in combination with T-shirts, which have outlines of the designs applied thereto, and the consumer uses the fabric crayons to color directly on the fabric or the T-shirt. This method of coloring is totally unsatisfactory, since the flexibility of the fabric prevents smooth and fluid strokes and creates tension, which prevents an even application of color from the crayons.

Another custom coloring procedure for transferring coloring designs to materials other than fabrics is described in U.S. Pat. No. 3,785,912 to Van Duesen, which discloses transferring a pattern or outline to a receptor sheet and subsequently coloring the receptor sheet with a conventional felt tip pen. This is essentially the same procedure described above with respect to the custom coloring of T-shirts.

All of the transfer kits and techniques of the prior art suffered from the disadvantage outlined above which are overcome by the method of the present invention. In which it provides a method for transferring creative artwork to leather (Cowhide, Calf, Pig, Goat, Kid, and Sheepskin) material or the like.

### SUMMARY OF THE INVENTION

It is the intention of this invention to provide a method in which it will captivate the interest of consumer who are captivated by leather (Cow hide, Calf, Pig, Goat, Kid, and Sheep) material described above. As well as the creative graphics rage in connection with a computer, and the widespread use of digital camera or manual cameras.

The object of the present invention is to provide a method permitting the creation of graphic designs, and images on a computer. Also, printing of the designs, and images on a transfer sheet using a computer printer; and heat pressing the personalized designs or graphics on a transfer sheet and then onto a conventional leather (Cowhide, Calf, Pig, Goat, Kid, and Sheepskin) material.

It is still another object of the present invention to provide a method, which creates graphics and personalized images on to leather (Cow hide, Calf, Pig, Goat, Kid, and Sheep) material than known heretofore, through conventional means.

The objects of the present invention are fulfilled by providing a method for applying a creative design, image or graphics to a leather (Cow hide, Calf, Pig, Goat, Kid, and Sheep) material, or the like, comprising the steps of:

(a) electronically creating the graphic design, or image;

(b) electronically transferring the image to a printer;

(c) printing the image with the aid of a printer on an obverse surface of a transfer sheet, the transfer sheet including a substrate with a first coating thereon transferable there from to said leather (Cow hide, Calf, Pig, Goat, Kid, and Sheep) material by the application of heat and pressure, and a second coating on said first coating, said second coating defining said obverse face and consisting essentially of Alcohol;

(d) positioning the obverse surface of said transfer sheet against said leather (Cow hide, Calf, Pig, Goat, Kid, and Sheep) material; and

(e) applying energy to the rear of said transfer sheet to transfer said image to said leather (Cow hide, Calf, Pig, Goat, Kid, and Sheep) material.

The image may be electronically generated by a digital camera or manual camera, so the image may be a picture of anyone or anything, which may be printed on a leather (Cow hide, Calf, Pig, Goat, Kid, and Sheep) material.

The image may be created and manipulated using a mouse or a drawing tablet and a graphic software and then saved and stored on the hard drive of the computer to be able to be displayed on the computer screen.

The printer utilized may be a multi-color printer or one that simply prints black on white. The image created on the computer screen can then be printed on the transfer paper using a conventional or high end 4 or more color printing press printers or copier.

The conventional graphic software will allow the images to be horizontally reversed. The reversed image would then be transferred to the printer and printed in reverse form onto the transfer sheet. When the image is printed in reverse on the back of the transfer paper it could then be heat pressed to the back of the transfer sheet. Then transfer the original, unreversed image from the screen directly onto the leather (Cowhide, Calf, Pig, Goat, Kid, and Sheepskin) material or the like.

### BRIEF DESCRIPTION OF THE DRAWINGS

The present invention will become more fully understood from the detailed description given herein, and the accompanying drawings which are given by way of illustration only, and thus are not limited to the present invention, and wherein:

FIG. 1 is a diagrammatic illustration of an exemplary computer system which might be used for practicing the method of the present invention;

FIG. 2 is an enlarged view of the exemplary, personalized, creative design illustrated on the monitor screen in the system of FIG. 1;

FIG. 3 illustrates a transfer sheet printed with the design created on the screen of FIG. 1 with the message thereon horizontally reversed;

FIG. 4 illustrates the step of applying rubbing alcohol on the top surface of the leather material or the like; and

FIG. 5 illustrates a standard heat press unit in ¾ view; and

FIG. 6 is an illustration of a heat press unit from the side view; and

FIG. 7 illustrates a transfer sheet being pressed on leather material by the use of heat and pressure between the upper platen 36 and the lower platen 38;

FIG. 8 illustrates leather material with the resulting image heat pressed with the message thereon correctly placed, as illustrated on screen 22 of monitor 14.

### DETAILED DESCRIPTION OF THE DRAWINGS

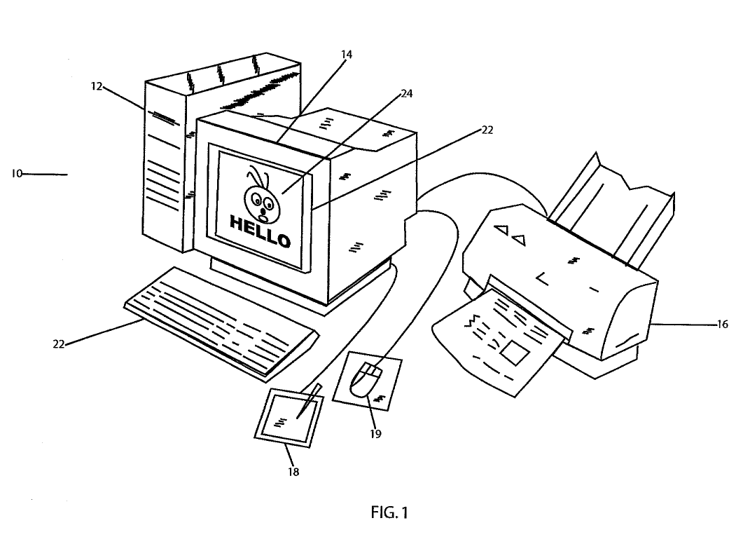

Referring in detail to FIG. 1, there is generally illustrated a computer system which may be utilized for practicing the method of the present invention. This computer system is generally illustrated 10, and includes a central processing unit (CPU) 12 of any commercially available type such as an (IBM PC), an (Apple, MCINTOSH PC), or any other suitable type. The computer system further includes a monitor 14 having a display screen 22, a keyboard 20, and an inkjet/bubble-jet/laser graphics color or black and white printer 16. The computer system 10 further includes a drawing tablet graphics input pad 18 such as a (“WACOM TABLET”) manufactured by Wacom Technologies. This drawing tablet graphics input pad permits one to create and alter, by hand, any desired pattern or photographed image on the pad. Then the pattern or photographed image so created on the pad is electronically transferred through an appropriate cable to the screen of monitor 14 through the CPU 12.

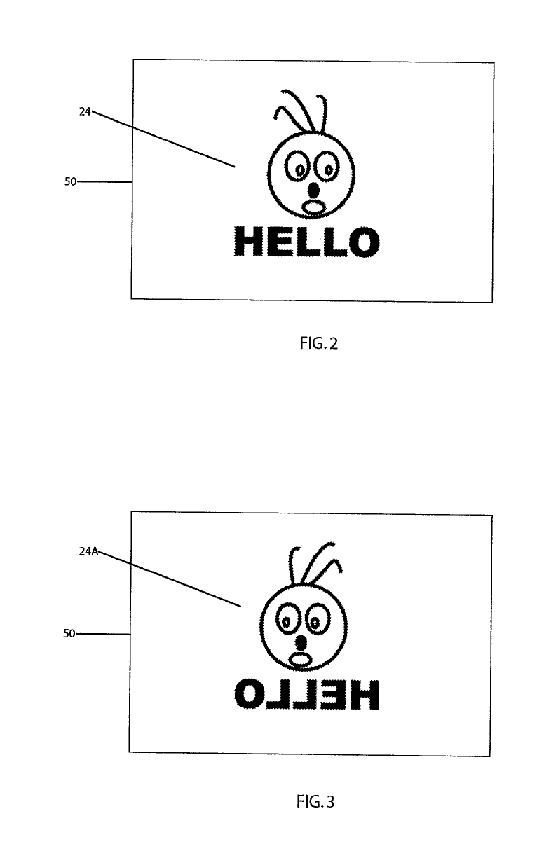

As further illustrated in FIG. 1, the creative design, pattern or photograph being created on graphics input pad 18 is the design 24 illustrated on screen 22, including an illustration of a face in the center of the screen. This design 24 is illustrated more detail in the enlarged view of FIG. 2.

It should be understood that this design 24 could be created on screen 22 by various means other than the graphics input pad 18. For example, it could be created by use of a well-known “mouse” which is also electrically coupled to the CPU 12; by means of keys on the keyboard 20; a hand-held light pen which is moved across the face of screen 22.

When it is desired to create an alphabetical message, such as “HELLO”, as part of the design 24, it is necessary to have some means of reversing the image from left to right within the CPU 12 before it is printed onto the transfer sheet 50 by the printer 16. This is best illustrated by the combination of the illustrations in FIGS. 2 and 3. FIG. 2 shows the image of the design 24 as it appears on screen 22 of monitor 14 and FIG. 3 shows the design 24A, as it would be printed as a reverse image on transfer sheet 50. The purpose of reversing the image from left to right, or vice versa, is so that when one applies a source of heat energy, such as from a heat press 30 in FIG. 6, to the backside 50A of transfer sheet 50, the image which is transferred to a leather or fabric 62 is the reverse image of that of FIG. 3, which corresponds to the same image that was originally created on screen 22 of monitor 14. This horizontal flip or image reversal within the CPU 12 may be easily accomplished by commercially available software such as Adobe Photoshop to make it possible to create alphabetical messages and images on the surface of fabrics without writing the message or creating image backwards initially.

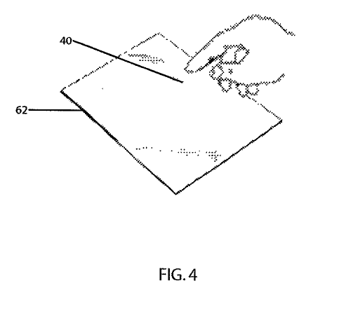

FIG. 4 illustrates how the rubbing alcohol from a sponge 40 is rubbed on to transfer sheet 50 and to leather 62 is performed. The leather 62 is laid flat, as illustrated, on an appropriate support surface, and the rubbing alcohol 40 is rubbed evenly across the back 62 and transfer sheet 50.

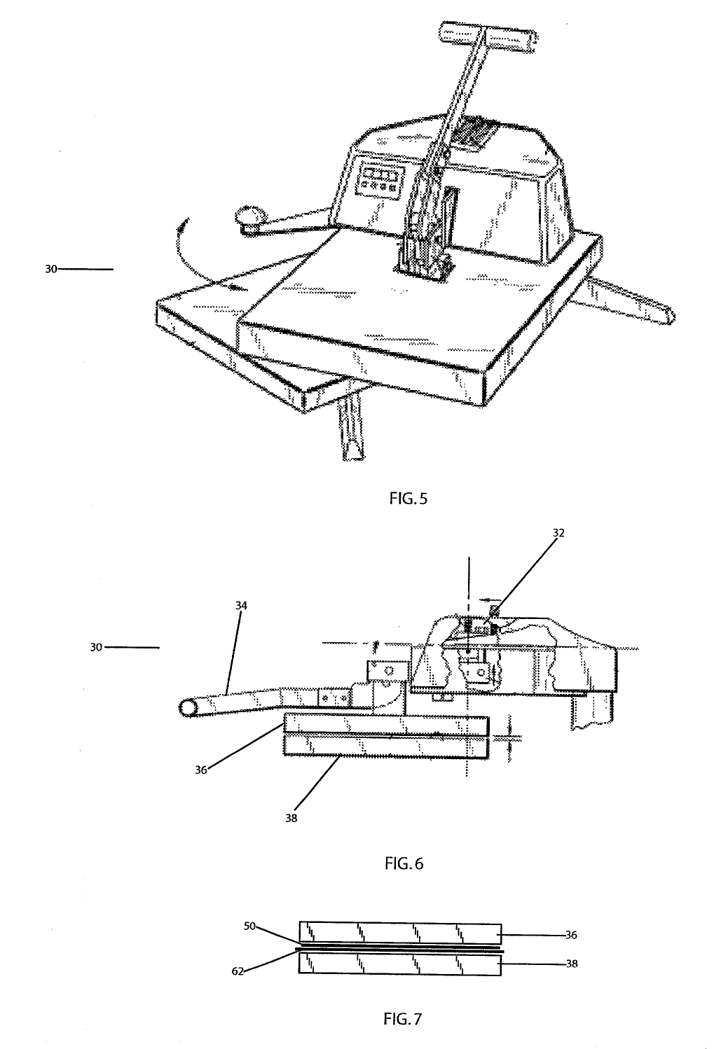

FIG. 5 and FIG. 6 illustrates the heat press machine 30 in ¾ and side view respectively. The heat press 30 consists of an arm 34, which is illustrated, in FIG. 6 in a closed position as well as a thermostat unit 32. Also, heat press 30 illustrated in FIG. 6 consists of an upper heat platen 36, which transfers an even amount of heat energy to the fabric material (leather) that is placed in between the upper platen 36 and lower platen 38.

FIG. 7 illustrates how the final step of heat transfer from transfer sheet 50 to leather 62 is performed. The leather 62 is laid flat, as illustrated, on the lower platen 38 surface, and the upper platen 36 is run and pressed across the back 52A of transfer sheet 50.

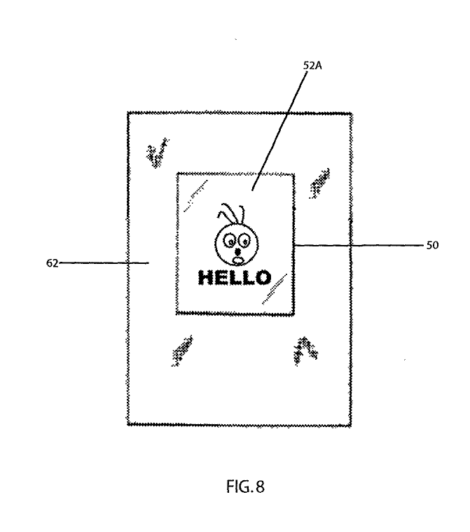

If the pattern being transferred is design 24, as illustrate on screen 22 of monitor 14, the resulting pattern on the leather 62 is illustrated in FIG. 8. As stated herein, the design 24 may be appropriately colored, by the multi-color printing capability of printer 16.

Transfer sheet 50 in a preferred embodiment comprises, in part, a transfer paper manufactured by Wyndstone Corporation under the trademark (PHOTOTRANS). Any other commercially-available transfer sheet may be utilized which has a substrate with a coating which is transferable to a receptor sheet upon the application of heat or pressure to the back of the substrate. It is a discovery of the present invention, however, that the transferable coating of (PHOTOTRANS), and other commercially-available transfer sheets, are not sufficiently receptive, or absorbent with respect to the inks normally used in computer-type to facilitate the printing/coloring of a good quality, clearly recognizable image on the transfer sheet and the subsequent transfer of the image to a fabric. This problem has been solved in accordance with the present invention by coating the transferable layer of conventional transfer paper and leather (Cow hide, Calf, Pig, Goat, Kid, and Sheep) material with a coating of Alcohol in a manner described.

Suitable transfer materials include the compositions from U.S. Pat. Nos. 5,501,902, 5,271,990 and 5,242,739. The contents of U.S. Pat. Nos. 5,501,902, 5,271,990 and 5,242,739 are herein incorporated by reference.

The present invention is most preferably directed to the use of dry transfer materials known in the art such as described in U.S. Pat. Nos. 5,501,902, 5,271,990 and 5,242,739. That is, dry release transfer materials per say are well known in the art, and any suitable dry release transfer material may be used in the invention. More specifically, the preferred dry release transfer materials of the present invention do not contain a water-soluble material for wet release.

Other suitable transfer materials include those described in U.S. Pat. Nos. 4,773,953 and 4,980,224 including a transfer sheet known as “TRANSEEZE” manufactured by Kimberly-Clark Corporation or any other commercially available transfer sheet which has a substrate with a coating which is transferable to a receptor sheet upon the application of heat or pressure to the back of the substrate, and that is coated with, for instance, Singapore Dammar Resin. The image-receptive heat transfer papers of U.S. Pat. Nos. 5,501,902, 5,271,990, and 5,242,739 may also be used. These papers generally have at least one film layer comprised of a thermoplastic polymer on a support. Common among all of these transfer materials is a carrier material which is capable of both dry release and adhesion.

The invention is preferably applicable to printers or copiers that can handle a transfer sheet. That is, the invention is applicable to use in, for instance, ink jet printers and copiers, thermal wax ribbon printers and copiers, laser toner copiers, Canon color laser copiers, etc. Whenever the transfer is used and it is necessary to drive the transfer image into the valleys of the receptor sheet, the process of the present invention should be used. The process of the invention fills the valleys of the receptor element, thereby filling the voids left by the initial transfer. This additional heating step prevents cracking of the transferred image and improved water resistance. The process of the invention should not be used with copiers/printers that overheat the transfer material (i.e. heating above the melting point of the transfer carrier) during the imaging stage.

Methods of transferring an image to a receptor element are also disclosed in the abovementioned patents. That is, the transfer materials per say utilized in the present invention are known in the art, as are methods for transferring the images to the receptor element using a single heat transfer step.

The invention is applicable to the following transfer materials. However, the invention is not limited to the following transfer materials.

### Image Receptive Heat Transfer Papers of U.S. Pat. No. 5,271,990

The process of the present invention is further applicable to the image receptive heat transfer materials of U.S. Pat. No. 5,271,990. For instance, the present invention also relates to a method of transferring image and non-image areas to a receptor element which comprises the steps of:

(a) placing an image on an image-receptive heat transfer material (i.e., by thermal ribbon printers, impact ribbon printers, dot matrix printers, crayons, printing or copying with a photocopier) which comprises:

a flexible cellulosic nonwoven web base sheet having top and bottom surfaces,

an image-receptive melt-transfer film layer overlaying the top surface of said base sheet, which image-receptive melt-transfer film layer is comprised of a thermoplastic polymer selected from the group consisting of polyolefins, polyesters, and ethylene-vinyl acetate copolymers and which melts in the range of from about 65 to about 180 degrees Celsius, in which the exposed surface of said image-receptive melt-transfer layer has a smoothness value, independent of the smoothness of the base sheet, of at least about 10 cc/minute as measured by a Sheffield Smoothness Tester,

(b) positioning the top or front surface of the transfer material having the image thereon against a receptor element,

(c) applying heat to the rear or bottom surface of the transfer material having the image thereon to transfer the image and non-image area to the receptor element,

(d) peeling away the support to obtain an imaged receptor element such as a fabric,

(e) placing a non-stick or tack free overlay sheet (e.g. thin silicone sheet) over the imaged receptor element such as a fabric, and

(f) pressing the overlay sheet (e.g. silicone sheet) by hand ironing to drive the coating into the fabric and removing the overlay sheet.

The present invention also relates to a method of transferring image and non-image areas to a receptor element which comprises the steps of:

(a) placing an image on an image-receptive heat transfer material (e.g. by thermal ribbon printers, impact ribbon printers, laser printers, dot matrix printers, crayons, or copying with a photocopier), which comprises:

a flexible cellulosic nonwoven web base sheet having top and bottom surfaces,

a melt extruded, melt-transfer film layer overlaying the top surface of said base sheet, which melt transfer film layer is comprised of a first thermoplastic polymer selected from the group consisting of polyolefins, polyesters, and ethylene-vinyl acetate copolymers, ethylene-methacrylic acid copolymers, and ethylene-acrylic acid copolymers and which melts in the range of from about 65 to about 180 degrees Celsius, and

a melt-extruded, image receptive film layer overlaying said melt-transfer layer, which image-receptive film layer is comprised of a second thermoplastic polymer selected from the group consisting of polyolefins, polyesters, and ethylene-vinyl acetate copolymers and which melts in the range of from about 65 to about 180 degrees Celsius, in which the exposed surface of said image-receptive film layer has a smoothness value, independent of the smoothness of the base sheet, of at least about 10 cc/minute as measured by a Sheffield Smoothness Tester,

(b) positioning the top or front surface of the transfer material having the image thereon against a receptor element,

(c) applying heat to the rear or bottom surface of the transfer material having the image thereon to transfer the image and non-image area to the receptor element,

(d) peeling away the support to obtain an imaged receptor element such as a fabric,

(e) placing a non-stick or tack-free overlay sheet (e.g. thin silicone sheet) over the imaged receptor element such as a fabric, and

(f) pressing the overlay sheet (e.g. silicone sheet) by hand ironing to drive the coating into the fabric and removing the overlay sheet.

### Image Receptive Heat Transfer Papers of U.S. Pat. NO. 5,242,739

The process of the present invention is further applicable to the image receptive heat transfer materials of U.S. Pat. No. 5,242,739. For instance, the present invention also relates to a method of transferring image and non-image areas to a receptor element which comprises the steps of:

(a) placing an image on an image-receptive heat transfer material (e.g. by thermal ribbon printers, impact ribbon printers, laser printers, dot matrix printers, crayons, or copying with a photocopier), which comprises:

a flexible cellulosic nonwoven web base sheet having top and bottom surfaces,

an image-receptive melt-transfer film layer overlaying the top surface of said base sheet, which image-receptive melt-transfer film layer comprises about 15 to about 80 percent by weight of a film-forming binder selected from the group consisting of ethylene-acrylic acid copolymers, polyolefins, and waxes and from about 85 to about 20 percent by weight of a powdered thermoplastic polymer selected from the group consisting of polyolefins, polyesters, polyamides, waxes, epoxy polymers, ethylene-acrylic acid copolymers, and ethylene-vinyl acetate copolymers, wherein each of said film-forming binder and said powdered thermoplastic polymer melts in the range of from about 65.degree. C. to about 180 degrees Celsius and said powdered thermoplastic polymer consists of particles which are from about 2 to about 50 micrometers in diameter,

(b) positioning the top or front surface of the transfer material having the image thereon against a receptor element,

(c) applying heat to the rear or bottom surface of the transfer material having the image thereon to transfer the image and non-image area to the receptor element,

(d) peeling away the support to obtain an imaged receptor element such as a fabric,

(e) placing a non-stick or tack-free overlay sheet (e.g. thin silicone sheet) over the imaged receptor element such as a fabric, and

(f) pressing the overlay sheet (e.g. silicone sheet) by hand ironing to drive the coating into the fabric and removing the overlay sheet.

The present invention also relates to a method of transferring image and non-image areas to a receptor element which comprises the steps of:

(a) placing an image on an image-receptive heat transfer paper (e.g. by thermal ribbon printers, impact ribbon printers, laser printers, dot matrix printers, crayons, or copying with a photocopier), which comprises:

a flexible cellulosic nonwoven web base sheet having top and bottom surfaces,

a melt transfer film layer overlaying the top surface of said base sheet, which melt transfer film layer comprises a film forming binder selected from the group consisting of ethylene-acrylic acid copolymers, polyolefins, and waxes and which melts in the range of from about 65 to about 180 degrees Celsius, and

an image-receptive film layer overlaying said melt-transfer film layer, which image-receptive film layer comprises about 15 to about 80 percent by weight of a film-forming binder selected from the group consisting of ethylene-acrylic acid copolymers, polyolefins, and waxes and from about 85 to about 20 percent by weight of a powdered thermoplastic polymer selected from the group consisting of polyolefins, polyesters, polyamides, waxes, epoxy polymers, ethylene-acrylic acid copolymers, and ethylene-vinyl acetate copolymers, wherein each of said film-forming binder and said powdered thermoplastic polymer melts in the range of from about 65.degree. C. to about 180 degrees Celsius and said powdered thermoplastic polymer consists of particles which are from about 2 to about 50 micrometers in diameter,

(b) positioning the top or front surface of the transfer material having the image thereon against a receptor element,

(c) applying heat to the rear or bottom surface of the transfer material having the image thereon to transfer the image and non-image area to the receptor element,

(d) peeling away the support to obtain an imaged receptor element such as a fabric,

(e) placing a non-stick or tack-free overlay sheet (e.g. thin silicone sheet) over the imaged fabric, and

(f) pressing the overlay sheet (e.g. silicone sheet) by hand ironing to drive the coating into the fabric and removing the overlay sheet.

### Image Receptive Heat Transfer Papers of U.S. Pat. NO. 5,501,902

The process of the present invention is further applicable to the image receptive heat transfer materials of U.S. Pat. No. 5,501,902. For instance, the present invention also relates to a method of transferring image and non-image areas to a receptor element which comprises the steps of:

(a) placing an image on an image-receptive heat transfer material having first and second surfaces (e.g. by laser printers, ink jet printers, dot-matrix printers, silk screening, direct and offset gravure printers, and photocopying), which comprises:

a first layer defining the first surface, said first layer having a front and rear surface, and

a second layer defining the second surface, which layer comprises particles of a thermoplastic polymer having largest dimensions of less than about 50 micrometers, from about 10 to about 50 weight percent of a film-forming binder, based on the weight of the thermoplastic polymer, and from about 0.2 to about 10 weight percent of an ink viscosity modifier, based on the weight of the thermoplastic polymer,

(b) positioning the second layer of the transfer material having the image thereon against a receptor element,

(c) applying heat to a rear surface of the transfer material having the image thereon to transfer the image and non-image area to the receptor element,

(d) peeling away the support to obtain an imaged receptor element such as a fabric,

(e) placing a non-stick or tack-free overlay sheet (e.g. thin silicone sheet) over the imaged receptor element such as a fabric, and

(f) pressing the overlay sheet (e.g. silicone sheet) by hand ironing to drive the coating into the fabric and removing the overlay sheet.

The present invention also relates to a method of transferring image and non-image areas to a receptor element which comprises the steps of:

(a) placing an image on an image-receptive heat transfer material having a front and rear surface (e.g. by laser printers, ink jet printers, dot-matrix printers, silk screening, direct and offset gravure printers, and photocopying), which comprises:

a first layer having first and second surfaces and selected from the group consisting of films and cellulosic nonwoven webs; and

a second layer which is receptive to ink jet ink overlaying the first surface of the first layer, which second layer melts from about 65 to about 180.degree. C. and comprises particles of a thermoplastic polymer having largest dimensions of less than about 50 micrometers, from about 10 to about 50 weight percent of a film-forming binder, based on the thermoplastic polymer, and from about 2 to about 20 weight percent of a cationic polymer, based on the weight of the thermoplastic polymer,

(b) positioning the second layer of the transfer material having the image thereon against a receptor element,

(c) applying heat to the rear surface of the transfer material having the image thereon to transfer the image and non-image area to the receptor element,

(d) peeling away the support to obtain an imaged receptor element such as a fabric,

(e) placing a non-stick or tack-free overlay sheet (e.g. thin silicone sheet) over the imaged receptor element such as a fabric, and

(f) pressing the overlay sheet (e.g. silicone sheet) by hand ironing to drive the coating into the fabric and removing the overlay sheet.

The present invention also relates to a method of transferring image and non-image areas to a receptor element which comprises the steps of:

(a) placing an image on an image-receptive heat transfer material having a front and rear surface (e.g. by laser printers, ink jet printers, dot-matrix printers, silk screening, direct and offset gravure printers, and photocopying), which comprises:

a first layer having first and second surfaces and selected from the group consisting of films and cellulosic nonwoven webs; and

a third layer overlaying the first surface of the first layer; and

a second layer which is receptive to ink jet ink overlaying the second layer, which second layer melts from about 65 to about 180.degree. C. and comprises particles of a thermoplastic polymer having largest dimensions of less than about 50 micrometers, from about 10 to about 50 weight percent of a film-forming binder, based on the thermoplastic polymer, and from about 2 to about 20 weight percent of a cationic polymer, based on the weight of the thermoplastic polymer,

(b) positioning the second layer of the transfer material having the image thereon against a receptor element,

(c) applying heat to the rear surface of the transfer material having the image thereon to transfer the image and non-image area to the receptor element,

(d) peeling away the support to obtain an imaged receptor element such as a fabric,

(e) placing a non-stick or tack-free overlay sheet (e.g. thin silicone sheet) over the imaged receptor element such as a fabric, and

(g) pressing the overlay sheet (e.g. silicone sheet) by hand ironing to drive the coating into the fabric and removing the overlay sheet.

### Transfer Material Containing Energy Sensitive Resin of U.S. Pat. No. 4,980,224

The invention is further applicable to the transfer sheet of U.S. Pat. No. 4,980,224. Thus, the present invention further relates to a method of applying an image to a receptor element, which comprises the steps of:

(a) generating an image on an obverse surface of a transfer sheet, said transfer sheet including a substrate, a first coating on said substrate of material transferable from said substrate to a receptor surface by the application of heat or pressure thereto, and a second coating on said first coating, said second coating consisting essentially of a mixture of Singapore Dammar resin and abrasive particles to form an abrasive surface for increasing the receptivity of the transfer sheet;

(b) positioning that obverse surface of said transfer sheet against said receptor element,

(c) applying energy (e.g. heat and/or pressure) to the rear of said transfer sheet to transfer said image to said receptor element,

(d) peeling away the substrate to obtain an imaged receptor element such as a fabric,

(e) placing a non-stick or tack-free overlay sheet (e.g. thin silicone sheet) over the imaged receptor element such as a fabric, and

(f) pressing the overlay sheet (e.g. silicone sheet) by hand ironing to drive the coating into the fabric and removing the overlay sheet.

The present invention further relates to a method of applying an image to a receptor element, which comprises the steps of:

(a) generating an image on an obverse surface of a transfer sheet, said transfer sheet including a substrate, a first coating on said substrate of material transferable from said substrate to a receptor surface by the application of heat or pressure thereto, and a second coating on said first coating, said second coating consisting essentially of a mixture of resin and sugar granules to form an abrasive surface for increasing the receptivity of the transfer sheet;

(b) positioning that obverse surface of said transfer sheet against said receptor element,

(c) applying energy (e.g. heat and/or pressure) to the rear of said transfer sheet to transfer said image to said receptor element,

(d) peeling away the substrate to obtain an imaged receptor element such as a fabric,

(e) placing a non-stick or tack-free overlay sheet (e.g. thin silicone sheet) over the imaged fabric, and

(f) pressing the overlay sheet (e.g. silicone sheet) by hand ironing to drive the coating into the fabric and removing the overlay sheet.

### Transfer Material Containing Energy Sensitive Resin of U.S. Pat. No. 4,966,815

The invention is further applicable to the transfer sheet of U.S. Pat. No. 4,966,815. Thus, the present invention further relates to a method of applying an image to a receptor element, which comprises the steps of:

(a) electronically generating an image,

(b) electronically transferring said image to a printer,

(c) printing said image with the aid of said printer on an obverse surface of a transfer sheet, said transfer sheet including a substrate with a first coating thereon transferable therefrom to said fabric by the application of heat or pressure thereto, and a second coating on said first coating, said second coating defining said obverse face and comprising Singapore Dammar resin;

(d) positioning that obverse surface of said transfer sheet against said receptor element,

(e) applying energy (e.g. heat and/or pressure) to the rear of said transfer sheet to transfer said image to said receptor element,

(f) peeling away the substrate to obtain an imaged receptor element such as a fabric,

(g) placing a non-stick or tack-free overlay sheet (e.g. thin silicone sheet) over the imaged receptor element such as a fabric, and

(h) pressing the overlay sheet (e.g. silicone sheet) by hand ironing to drive the coating into the fabric and removing the overlay sheet.

The benefits of the present invention are applicable to laser, black and white, and color copiers and printers as well as other copiers and printers such as ink jet.

The following examples are provided for a further understanding of the invention, however, the invention is not to be construed as being limited thereto.

1. A method of transferring a design such as a picture and or a pattern to leather (Cow hide, Calf, Pig, Goat, Kid, and Sheep skin) material using a computer from a transfer sheet, comprising the steps of:
generating said design on the reverse surface of a transfer sheet by the application of energy thereto, while juxtaposing the rear surface of said transfer sheet with a layer of energy transferable material to provide a transferable mirror image of said design on the said rear surface, said transfer sheet including a printed picture and or pattern to apply said energy to said obverse surface, said design being formed of energy transferable material on the rear surface of said transfer sheet and being used as a guide with respect to which said design is created;
placing said rear surface containing said design of photograph or pattern and said transferable mirror image of said design contiguous with a desired position on a surface of said leather (Cow hide, Calf, Pig, Goat, Kid, and Sheep skin) material by visually aligning said design on said obverse surface with said desired position; and
applying energy throughout the obverse surface of said transfer sheet to transfer both said mirror image of said design of photograph or pattern from said rear surface to said desired area on said leather (Cow hide, Calf, Pig, Goat, Kid, and Sheep skin) material to thereby reproduce said design superimposed on said design of photograph or pattern on said leather (Cow hide, Calf, Pig, Goat, Kid, and Sheep skin) material.

2. The method of claim 1 wherein said energy applied to transfer said design of photograph or pattern to said leather (Cow hide, Calf, Pig, Goat, Kid, and Sheep skin) material is heat.
